(19) United States
(12) Patent Application Publication
(10) Pub. No.: US 2026/0044457 A1
(43) Pub. Date: Feb. 12, 2026

(54) Device Access Circuit and Hub

(71) Applicant: Anker Innovations Technology Co., Ltd., Changsha (CN)

(72) Inventor: Chaoyi Yu, Shenzhen (CN)

(21) Appl. No.: 19/290,524

(22) Filed: Aug. 5, 2025

(30) Foreign Application Priority Data
Aug. 6, 2024 (CN) 202421892442.7

(51) Int. Cl. G06F 13/10; G06F 9/4401

(52) U.S. Cl. CPC G06F 13/102; G06F 9/4418

(57) ABSTRACT

The present application describes a device access circuit and a hub. The device access circuit comprises a first reset chip, a second reset chip, and a logic circuit. An input terminal of the first reset chip and an input terminal of the second reset chip are connected to ports of a device, respectively. An output terminal of the first reset chip and an output terminal of the second reset chip are connected to input terminals of the logic circuit, respectively. The first reset chip and the second reset chip are configured to output different signal levels in response to the device being either in a forward or reverse connection. The logic circuit is configured to output a high-level signal in response to the first reset chip and the second reset chip outputting different signal levels.

### CROSS-REFERENCE OF RELATED APPLICATION

The present application claims priority to Chinese Patent Application No. 202421892442.7, filed on Aug. 6, 2024, which is herein incorporated by reference by its entirety.

### TECHNICAL FIELD

The present application relates to the technical field of signal transmission, in particular to a device access circuit and a hub.

### BACKGROUND

With the development of technology, signal interaction between devices has become increasingly frequent. Generally speaking, signal transmission between two devices can be achieved by connecting them through a port. Port types of devices are diverse. For example, devices with Type-C ports are widely used.

For devices that need to connect via a Type-C port, the current alternative chip-based on hardware circuit design cannot control the on and off states of port power supply. In the context of rapid iteration in consumer electronics, keeping the port constantly powered (e.g., live port) can lead to issues and risks where connected devices may not be recognized, and it can also easily cause circuit failures, creating safety hazards. Therefore, the reliability of hardware circuits of conventional access devices is low.

### SUMMARY

It may be desirable to provide a reliable device access circuit and a hub. In a first aspect, the present application provides a device access circuit, comprising a first reset chip, a second reset chip, and a logic circuit. An input terminal of the first reset chip and an input terminal of the second reset chip are connected to a first side port and a second side port of an accessed device, respectively. An output terminal of the first reset chip and an output terminal of the second reset chip are connected to input terminals of the logic circuit, respectively. An output terminal of the logic circuit is connected to a current-limiting switch, and the output terminal of the first reset chip is connected to a toggle switch.

The first reset chip and the second reset chip are configured to output different signal levels when (e.g., in response to) the first side port and the second side port of the accessed device are in a forward or reverse connection. The logic circuit is configured to output a high-level signal when (e.g., in response to) the first reset chip and the second reset chip output different signal levels, so as to conduct the current-limiting switch.

In a second aspect, the present application provides a hub (e.g., a charging hub, a powered USB hub) comprising a current-limiting switch, a toggle switch, and the device access circuit as described above.

The aforementioned device access circuit and hub may comprise the first reset chip, the second reset chip, and the logic circuit. The input terminal of the first reset chip and the input terminal of the second reset chip are connected to the ports of the accessed device, respectively. The output terminal of the first reset chip and the output terminal of the second reset chip are connected to the input terminals of the logic circuit, respectively. The output terminal of the logic circuit is connected to the current-limiting switch, and the output terminal of the first reset chip is connected to the toggle switch. The first reset chip and the second reset chip are configured to output different signal levels when the port of the accessed device is in a forward or reverse connection, and the logic circuit is configured to output a high-level signal when the first reset chip and the second reset chip output different signal levels, so as to conduct the current-limiting switch. Thus, the toggle switch can access different signal levels when the port of the accessed device is in the forward or reverse connection, so as to switch different signal channels and recognize the forward or reverse connection. In addition, the logic circuit can control the current-limiting switch to conduct when the port of the accessed device is in the forward or reverse connection, so as to supply power to (e.g., charge) the accessed device, thereby preventing the ports from being live (e.g., powered) all the time, and ensuring high working reliability.

### BRIEF DESCRIPTION OF THE DRAWINGS

In order to explain technical solutions in the present application more clearly, the accompanying drawings required for use in the description will be introduced simply. Apparently, the accompanying drawings described below show only some examples of the present application. A person of ordinary skill in the art can obtain other drawings according to these drawings without any creative effort.

FIG. 1 is a structural block diagram of a device access circuit in one example;

FIG. 2 is a structural block diagram of a device access circuit in another example;

FIG. 3 is a schematic structural diagram of a device access circuit in one example; and

FIG. 4 is a structural block diagram of a device access circuit in yet another example.

### DETAILED DESCRIPTION

In order to facilitate the understanding of the present application, the present application will be described more comprehensively below with reference to relevant accompanying drawings. Examples of the present application are shown in the drawings. However, the present application can be implemented in many different forms, and is not limited to the examples described herein. Rather, these examples are provided to make the disclosure of the present application more thorough and comprehensive.

Unless otherwise defined, all technological and scientific terms used herein have the same meanings as commonly understood by those of ordinary skill in the technical field of the present application. The terms used in the description of the present application are only for the purpose of describing specific examples, but are not intended to limit the present application.

It is understandable that the terms “first”, “second”, etc. used in the present application can be used to describe various elements, but these elements are not restricted by these terms. These terms are only used to distinguish a first element from another element. For example, within the scope of the present application, a first resistor may be referred to as a second resistor, and similarly, a second resistor may be referred to as a first resistor. Both the first resistor and the second resistor are resistors, but they are not the same resistor.

The term “connection” in the following description should be understood as “electrical connection”, “communication connection”, etc. if electrical signals or data are transmitted over connected circuits, modules, units, etc.

It is understandable that “at least one” refers to one or more, and “more” refers to two or more. “At least part of an element” refers to the partial or entire element.

When used herein, the singular forms of “a”, “an”, and “said/the” may also include plural forms, unless the context clearly indicates otherwise. It should also be understood that the terms “comprise/include” or “have” and the like designate the existence of the stated features, wholes, steps, operations, components, parts, or combinations thereof, but do not exclude the existence or addition of one or more other features, wholes, steps, operations, components, parts, or combinations thereof. Meanwhile, the term “and/or” used in the description includes any and all combinations of relevant items listed.

In one example, a device access circuit is provided, configured to connect to a port of an accessed device (e.g., a connected device) and establish a connection with the accessed device. The type of the port of the accessed device is not limited. For example, the port of the accessed device may be a Type-C port or a different type of port. A Type-C port may have a symmetrical structure, so when in use, it is possible to confuse forward connection with reverse connection. In conventional technologies, some downlink Type-C port designs use MUX (Multiplexer) chips for high-speed signal recognition and switching during forward and reverse connection of devices, to control the on and off states of port power supply.

However, the MUX chips are complex in manufacturing and costly. The device access circuit provided in the present application can supply power to the port of the accessed device regardless of forward or reverse connection, and can recognize whether the port of the accessed device is in forward or reverse connection, facilitating the switching of different signal channels and better coordination with the port of the accessed device. The device access circuit provided in the present application can be used instead of a MUX chip, with lower usage cost and higher resource utilization.

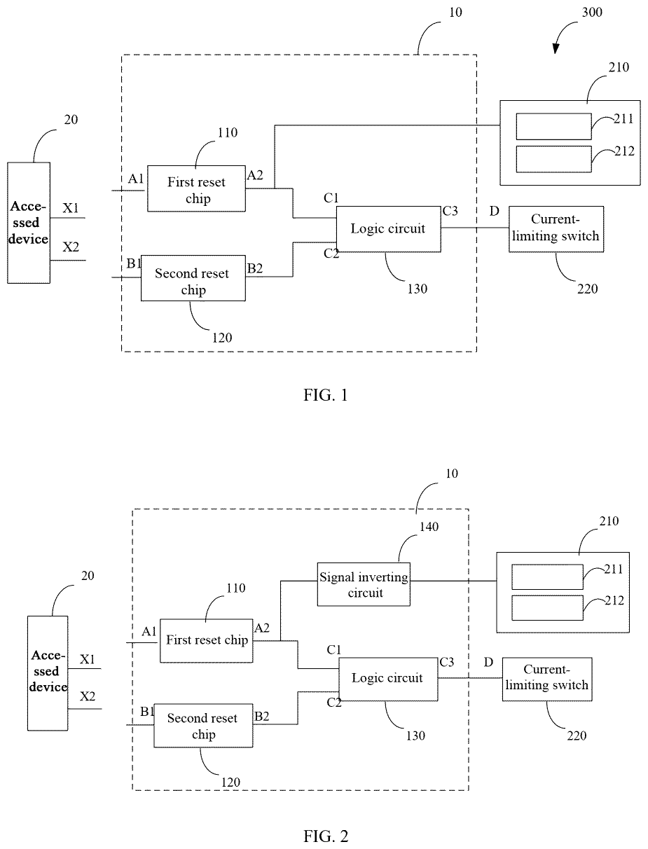

Specifically, as shown in FIG. 1, the device access circuit 10 includes a first reset chip 110, a second reset chip 120, and a logic circuit 130. An input terminal A1 of the first reset chip 110 and an input terminal B1 of the second reset chip 120 may be connected to a port of an accessed device 20. An output terminal A2 of the first reset chip 110 may be connected to an input terminal C1 of the logic circuit 130. An output terminal B2 of the second reset chip 120 may be connected to an input terminal C2 of the logic circuit 130. An output terminal C3 of the logic circuit 130 may be connected to a current-limiting switch 220. The output terminal A2 of the first reset chip 110 may be connected to a toggle switch 210. The first reset chip 110 and the second reset chip 120 may be configured to output different signals (e.g., logic level signals, voltage level signals, signal levels) when the port of the accessed device is in forward or reverse connection.

The logic circuit 130 may be configured to output a high-level signal to conduct the current-limiting switch 220, when the first reset chip 110 and the second reset chip 120 output different signals (e.g., logic level signals, voltage level signals).

The input terminal A1 of the first reset chip 110 and the input terminal B1 of the second reset chip 120 may be connected to different positions of the port of the accessed device, respectively. The first reset chip 110 may be configured to output different signals based on a magnitude relationship between an accessed voltage (e.g., an input voltage) and its monitoring voltage. The monitoring voltage refers to a reference voltage used by the first reset chip 110 for comparison with accessed voltages. The different signals may be a high-level signal and a low-level signal. Generally, the first reset chip 110 may be configured to output a low-level signal when the accessed voltage is less than its monitoring voltage, and may be configured to output a high-level signal when the accessed voltage is greater than or equal to its monitoring voltage. Similarly, the second reset chip 120 may be configured to output different signals based on a magnitude relationship between an accessed voltage and its monitoring voltage. Generally, the second reset chip 120 may be configured to output a low-level signal when the accessed voltage is less than its monitoring voltage, and may be configured to output a high-level signal when the accessed voltage is greater than or equal to its monitoring voltage. The monitoring voltage refers to a reference voltage used by the second reset chip 120 for comparison with accessed voltages.

It should be noted that forward connection and reverse connection represent two opposite directions of connection between the port of the accessed device and the device access circuit. For example, the port of the accessed device 20 includes a first side port X1 and a second side port X2. If the first side port X1 is connected to the input terminal Al of the first reset chip 110, and the second side port X2 is connected to the input terminal B1 of the second reset chip 120, such connection is defined as forward connection. If the first side port X1 is connected to the input terminal B1 of the second reset chip 120, and the second side port X2 is connected to the input terminal A1 of the first reset chip 110, such connection is defined as reverse connection.

The first reset chip 110 and the second reset chip 120 may be configured to output different signals when the port of the accessed device is in forward or reverse connection. For example, the first reset chip 110 may be configured to output different signals when the port of the accessed device is in forward or reverse connection, the second reset chip 120 may be configured to output different level signals (e.g., signal levels) when the port of the accessed device is in a forward or reverse connection. Moreover, when the port of the accessed device is in forward connection, the first reset chip 110 and the second reset chip 120 output different signals. When the port of the accessed device is in reverse connection, the first reset chip 110 and the second reset chip 120 output different signals. For example, when the port of the accessed device is in the forward connection, the first reset chip 110 outputs a low-level signal, while the second reset chip 120 outputs a high-level signal; or when the port of the accessed device is in the reverse connection, the first reset chip 110 outputs a high-level signal, while the second reset chip 120 outputs a low-level signal.

The toggle switch 210 is connected to the output terminal A2 of the first reset chip 110. The toggle switch 210 includes a plurality of signal channels, such as a forward connection signal channel 211 and a reverse connection signal channel 212. The toggle switch 210 can access different level signals (e.g., signal levels) when (e.g., in response to) the first side port and the second side port of the accessed device are in a forward or reverse connection, so as to switch different signal channels and recognize the forward or reverse connection. As such, a matching signal channel can be connected when the first side port and the second side port of the accessed device are in forward or reverse connection. For example, when the first side port and the second side port of the accessed device are in forward connection, the first reset chip 110 outputs a low-level signal, and the forward connection signal channel 211 of the toggle switch 210 is conducted (e.g., turned on). When the first side port and the second side port of the accessed device are in reverse connection, the first reset chip 110 outputs a high-level signal, and the toggle switch 210 switches to conduct the reverse connection signal channel 212.

The logic circuit 130 is configured to output a high-level signal when the first reset chip 110 and the second reset chip 120 output different level signals, so as to conduct the current-limiting switch 220. The logic circuit 130 implements a corresponding logic determination function based on its structure. For example, the logic circuit 130 is configured to output a high-level signal when the first reset chip 110 and the second reset chip 120 output different level signals. In particular, the logic circuit 130 may be configured to output a high-level signal when the first reset chip 110 outputs a low-level signal and the second reset chip 120 outputs a high-level signal. Alternatively, the logic circuit 130 may be configured to output a high-level signal when the first reset chip 110 outputs a high-level signal and the second reset chip 120 outputs a low-level signal. The structure of the logic circuit 130 is not limited as long as it can implement the corresponding function.

An input terminal H of the current-limiting switch 220 may be connected to the output terminal C3 of the logic circuit 130. Depending on the signals output by the logic circuit 130, the current-limiting switch 220 may be in an on or off state. For example, when the logic circuit 130 outputs high-level signals, the current-limiting switch 220 is conducted (e.g., turned on). The current-limiting switch 220 may be used to access voltage (e.g., input voltage). When the current-limiting switch 220 is conducted, the current-limiting switch 220 can deliver (e.g., transmit) the accessed voltage to the port of the accessed device, so as to supply power to the port of the accessed device.

In an example, the device access circuit 10 includes the first reset chip 110, the second reset chip 120, and the logic circuit 130. The input terminal Al of the first reset chip 110 and the input terminal B1 of the second reset chip 120 may be connected to the port of the accessed device. The output terminal A2 of the first reset chip 110 may be connected to the input terminal C1 of the logic circuit 130. The output terminal B2 of the second reset chip 120 may be connected to the input terminal C2 of the logic circuit 130. The output terminal C3 of the logic circuit 130 may be connected to the input terminal H of the current-limiting switch 220, and the output terminal A2 of the first reset chip 110 may be connected to the toggle switch 210. The first reset chip 110 and the second reset chip 120 may be configured to output different level signals when the port of the accessed device is in forward or reverse connection. The logic circuit 130 may be configured to output a high-level signal when the first reset chip 110 and the second reset chip 120 output different level signals, so as to conduct the current-limiting switch 220. Thus, the toggle switch 210 can access different level signals when the port of the accessed device is in forward or reverse connection, so as to switch different signal channels and recognize the forward or reverse connection. In addition, the logic circuit 130 can control the current-limiting switch 220 to conduct when the port of the accessed device is in forward or reverse connection, so as to supply power to the accessed device, thereby preventing the port from being live (e.g., powered) all the time, and ensuring high working reliability.

In one example, as shown in FIG. 2, the device access circuit may further include a signal inverting circuit 140. The output terminal A2 of the first reset chip 110 may be connected to the toggle switch 210 through the signal inverting circuit 140. The signal inverting circuit 140 may be in an on or off state when the output terminal A2 of the first reset chip 110 outputs different level signals.

Specifically, the signal inverting circuit 140 may be configured to invert the signals output by the first reset chip 110 and then to transmit the inverted signals to the toggle switch 210. The signal inverting circuit 140 can help the toggle switch 210 operate normally. For example, if the default channel of the toggle switch 210 is a reverse connection signal channel 212, and the first reset chip 110 outputs a low-level signal when the port of the accessed device is in forward connection, the signal inverting circuit 140 can convert the low-level signal into a high-level signal and transmit the high-level signal to the toggle switch 210, so that the toggle switch 210 switches to the forward connection signal channel to match the port direction of the accessed device. Through the inverting effect of the signal inverting circuit 140, the toggle switch 210 can switch to a working state that matches the port direction of the accessed device 20, thereby ensuring normal operation of the circuit.

For example, in one example, when the output terminal of the first reset chip 110 outputs a low-level signal, the signal inverting circuit 140 is in an off state; and when the output terminal of the first reset chip 110 outputs a high-level signal, the signal inverting circuit 140 is in an on state.

Specifically, when the output terminal A2 of the first reset chip 110 outputs a low-level signal, the signal inverting circuit 140 is in an off state, and the signal inverting circuit 140 can output a high-level signal to achieve a function of signal inversion. When the output terminal A2 of the first reset chip 110 outputs a high-level signal, the signal inverting circuit 140 is in an on state, and the signal inverting circuit 140 can output a low-level signal to achieve a function of signal inversion.

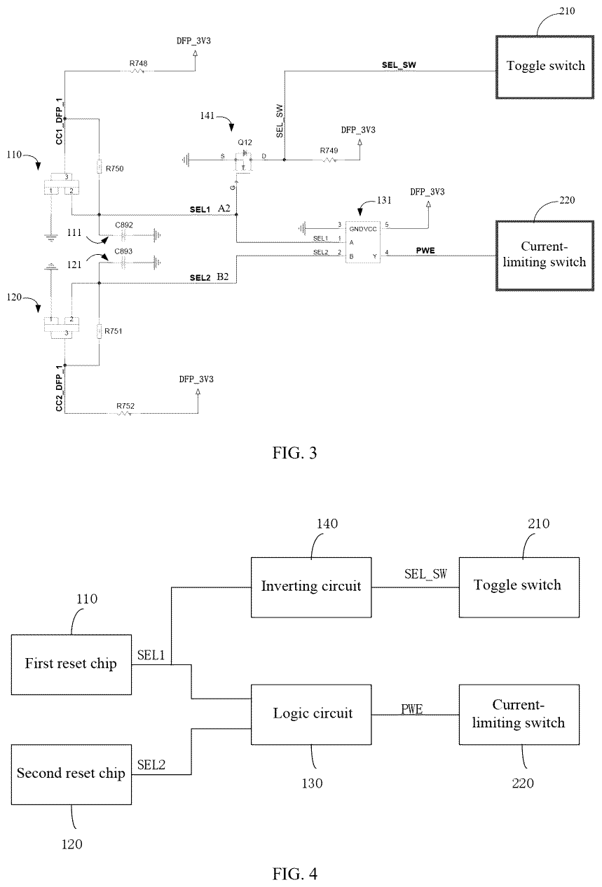

The structure and type of the signal inverting circuit 140 are not limited herein, as long as it can achieve the function of signal inversion. For example, as shown in FIG. 3, the signal inverting circuit 140 comprises a control switch 141. A control terminal G of the control switch 141 may be connected to the output terminal A2 of the first reset chip 110, a first terminal S of the control switch 141 may be grounded, and a second terminal D of the control switch 141 may be connected to the toggle switch 210.

The control switch 141 may be in an on or off state based on the level of the signals applied to (e.g., received at) the control terminal G, so that the signals applied to the toggle switch 210 may be different. The toggle switch 210 may be connected to the second terminal D of the control switch 141. For example, the control switch 141 may be turned off when a low-level signal is applied to its control terminal G, resulting in a high-level signal at the second terminal D of the control switch 141, and the toggle switch 210 receives a high-level signal. Thus, the control switch achieves a function of signal inversion, with a simple structure. Further, the type of the control switch 141 may be various, such as an MOS (Metal Oxide Semiconductor) transistor or a triode. In this example, the control switch may be an NMOS (N-channel Metal Oxide Semiconductor) transistor.

In one example, the monitoring voltages of the first reset chip 110 and the second reset chip 120 may be identical. Specifically, the monitoring voltage refers to a reference voltage used by the first reset chip 110 and the second reset chip 120 for comparison with accessed voltages. The monitoring voltage may be determined based on the structures of the first reset chip 110 and the second reset chip 120, and may be a fixed value after their structures are determined. When connected to the port of the accessed device 20, different voltages are applied to the first reset chip 110 and the second reset chip 120. When the monitoring voltages of the first reset chip 110 and the second reset chip 120 are identical, and the input terminal Al of the first reset chip 110 and the input terminal B1 of the second reset chip 120 are connected to the port of the accessed device, the first reset chip 110 compares the accessed voltage with the identical monitoring voltage, the second reset chip 120 compares the accessed voltage with the identical monitoring voltage, and then the first reset chip 110 and the second reset chip 120 may output corresponding signals based on the magnitude relationships between the accessed voltages and the monitoring voltage. This process can improve the accuracy of comparison results, and help the first reset chip 110 and the second reset chip 120 output different signals when the port of the accessed device is in forward connection, and also output different signals when the port of the accessed device is in reverse connection.

For example, when the port of the accessed device is in forward connection, the voltage applied to the first reset chip 110 is less than its monitoring voltage, the first reset chip 110 may output a low-level signal, the voltage accessed to the second reset chip 120 is greater than or equal to its monitoring voltage, and the second reset chip 120 may output a high-level signal. When the port of the accessed device is in reverse connection, the voltage accessed to the first reset chip 110 is greater than or equal to its monitoring voltage, the first reset chip 110 may output a high-level signal, the voltage applied to the second reset chip 120 is less than its monitoring voltage, and the second reset chip 120 may output a low-level signal.

In this example, the monitoring voltages of the first reset chip 110 and the second reset chip 120 may be identical, the first reset chip 110 and the second reset chip 120 compare the accessed voltages with the identical monitoring voltage and then output corresponding signals based on the magnitude relationships between the accessed voltages and the monitoring voltage, which can improve the accuracy of comparison results and ensure the normal operation of the circuit.

Further, in one example, the structures of the first reset chip 110 and the second reset chip 120 are the same. The same structure of the first reset chip 110 and the second reset chip 120 may indicate that the first reset chip 110 and the second reset chip 120 are the same in type or model. For example, the first reset chip 110 and the second reset chip 120 may be both MSI Electronics ME2805A1.

In some examples, the same structure of the first reset chip 110 and the second reset chip 120 can reduce working errors caused by device differences, and may help improve the operating performance of the device access circuit.

In one example, the logic circuit 130 may comprise a NAND gate circuit 131. Specifically, the first input terminal A of the NAND gate circuit 131 may be connected to the output terminal A2 of the first reset chip 110, the second input terminal B of the NAND gate circuit 131 may be connected to the output terminal B2 of the second reset chip 120, and the output terminal Y of the NAND gate circuit 131 may be connected to the current-limiting switch 220. When the first reset chip 110 and the second reset chip 120 are connected to the accessed device, regardless of whether the port of the accessed device is in forward or reverse connection, the first reset chip 110 and the second reset chip 120 may output different level signals. When receiving different signals at the two input terminals, the NAND gate circuit 131 may first perform “AND” processing on the two input signals, then perform “NOT” processing on the “AND”-processed signals, and finally output a high-level signal.

In this example, the NAND gate circuit 131 can output a high-level signal when the first reset chip 110 and the second reset chip 120 output different signals, to conduct the current-limiting switch 220, thereby achieving the purpose of supplying power to the port of the accessed device.

In one example, as shown in FIG. 3, the device access circuit may further include a first pull-up resistor R748 and a second pull-up resistor R752. The input terminal CC1 DFP1 of the first reset chip 110 may be configured to access a power supply DFP_3V3 through the first pull-up resistor R748, and the input terminal CC2 DFP1 of the second reset chip 120 may be configured to access the power supply DFP_3V3 through the second pull-up resistor R752. The resistance values of the first pull-up resistor R748 and the second pull-up resistor R752 are not limited herein and can be determined according to actual requirements. The first pull-up resistor R748 can pull up the voltage at the input terminal CC1 DFP1 of the first reset chip 110 to correspond to the voltage of the accessed power supply DFP_3V3, and the second pull-up resistor R752 can pull up the voltage at the input terminal CC2 DFP1 of the second reset chip 120 to correspond to the voltage of the accessed power supply DFP_3V3. Therefore, the first pull-up resistor R748 can help the first reset chip 110 operate normally, and the second pull-up resistor R752 can help the second reset chip 120 operate normally. Further, the first pull-up resistor R748 and the second pull-up resistor R752 can access the power supplies of the same voltage, and the first pull-up resistor R748 and the second pull-up resistor R752 may be of the same type to better ensure the uniformity and stability of the circuit structure.

In addition, the device access circuit 10 may further include a third pull-up resistor R750 and a fourth pull-up resistor R751. The third pull-up resistor R750 may be connected to the first reset chip 110 to ensure the stability of the output level of the first reset chip 110, and the fourth pull-up resistor R751 may be connected to the second reset chip 120 to ensure the stability of the output level of the second reset chip 120.

In one example, as shown in FIG. 3, the device access circuit 10 may further include a first filter circuit 111 and a second filter circuit 121. The first filter circuit 111 may be connected to the first reset chip 110, and the second filter circuit 121 may be connected to the second reset chip 120. The first filter circuit 111 can filter out clutter that affects the operation of the first reset chip 110, which can help improve the operating performance of the first reset chip 110. The second filter circuit 121 can filter out clutter that affects the operation of the second reset chip 120, which can help improve the operating performance of the second reset chip 120.

In one example, the structures of the first filter circuit 111 and the second filter circuit 121 may be the same. The first filter circuit 111 is a circuit that assists the first reset chip 110 in operation, and the second filter circuit 121 is a circuit that assists the second reset chip 120 in operation. When the structures of the first filter circuit 111 and the second filter circuit 121 are the same, the first reset chip 110 and the second reset chip 120 can operate under more similar conditions, and output different signals only due to different accessed signals, thereby reducing other interferences and improving the accuracy of signals output by the first reset chip 110 and the second reset chip 120.

The structures of the first filter circuit 111 and the second filter circuit 121 are described with reference to FIG. 3. For example, as shown in FIG. 3, the first filter circuit 111 includes a first filter capacitor C892, which plays a filtering role. One end of the first filter capacitor C892 is connected to the output terminal A2 of the first reset chip 110, and the other end is grounded. The second filter circuit 121 includes a second filter capacitor C893, which plays a filtering role. One end of the second filter capacitor C893 is connected to the output terminal B2 of the second reset chip 120, and the other end is grounded. The first filter circuit and the second filter circuit may have other structures, as long as those skilled in the art consider them achievable.

In one example, as shown in FIG. 1, a hub 300 is provided, including the current-limiting switch 220, the toggle switch 210, and the device access circuit 10 described herein.

To better understand the above example, the following is a detailed explanation in combination with a specific example. In one example, as shown in FIG. 3 and FIG. 4, the hub 300 may include the current-limiting switch 220, the toggle switch 210, and the device access circuit 10. The device access circuit 10 may include the first reset chip 110, the second reset chip 120, the logic circuit 130, the signal inverting circuit 140, the first pull-up resistor R748, the second pull-up resistor R752, the third pull-up resistor R750, the fourth pull-up resistor R751, the first filter circuit 111, and/or the second filter circuit 121. The first filter circuit 111 may include the first filter capacitor C892, and the second filter circuit 121 may include the second filter capacitor C893. The signal inverting circuit 140 may comprise an NMOS transistor. The first reset chip 110 and the second reset chip 120 may be both MSI Electronics ME2805A1. The logic circuit 130 may comprise a NAND gate circuit 131, specifically MSKSEMI SN74LVC1G00. The current-limiting switch 220 may be ETA6280. The toggle switch 210 may be a high-speed toggle switch, specifically Grand Microelectronics ASW3410. The accessed device may be an electronic device with Type-C ports (e.g., x1 and x2).

The working process of the device access circuit includes: The first pull-up resistor R748 connected to the first reset chip 110 may be a 12K resistor. The first pull-up resistor R748 pulls up the voltage to 3.3V. The second pull-up resistor R752 connected to the second reset chip 120 may be a 12K resistor, and the second pull-up resistor R752 pulls up the voltage to 3.3V. The Type-C port may guarantee an output capacity of 1.5 A. After the input terminal CC1 DFP1 of the first reset chip 110 and the input terminal CC2 DFP1 of the second reset chip 120 are plugged into the accessed device, due to the internal resistance Rd of the accessed device, the level of the input terminal CC1 DFP1 of the first reset chip 110 may drop below 2.63V by voltage division, and the level of the input terminal CC2 DFP1 of the second reset chip 120 may drop below 2.63V by voltage division. When it is detected that the level of the input terminal CC1 DFP1 of the first reset chip 110 is less than a specific value (e.g., 2.63V), and the level of the input terminal CC2 DFP1 of the second reset chip 120 is less than a specific value (e.g., 2.63V), the output terminals of the first reset chip 110 and the second reset chip 120 may output a low-level signal.

Case 1: When the accessed device is plugged forward, the signal level of the input terminal CC1 DFP1 of the first reset chip 110 may be lower than the monitoring voltage of the first reset chip 110 due to voltage division by the resistor, the signal SEL1 output by the first reset chip 110 may be a low-level signal, and the signal SEL2 output by the second reset chip 120 may be a high-level signal. After the signals pass through the NAND gate circuit, the output signal PWE may be a high-level signal, the current-limiting switch 220 may be turned on, and the power supply to the Type-C port may be turned on. Since the default channel of the toggle switch 210 is the reverse connection signal channel, the signals are inverted through the NMOS transistor. When SEL1 is a low-level signal and SEL_SW is a high-level signal, the toggle switch 210 can be switched to the forward connection signal channel.

Case 2: When the accessed device 20 is plugged reversely, the level at the input terminal CC2 DFP1 of the second reset chip 120 may be lower than the monitoring voltage of the second reset chip 120 due to voltage division by the resistor, and the signal SEL2 output by the second reset chip 120 may be a low-level signal. Since SEL1 is a high-level signal at this time, the toggle switch 210 may remain in the reverse connection signal channel. At the same time, SEL2 may be a low-level signal. After the signals pass through the NAND gate circuit, the signal PWE output by the NAND gate circuit may be a high-level signal, the current-limiting switch 220 may be turned on, and the power supply to the Type-C port of the accessed device 20 may be turned on.

Case 3: When the accessed device 20 is not plugged, SEL1 is a high-level signal, and the toggle switch 210 maintains the default channel. When no device is accessed, the input terminal CC1 DFP1 of the first reset chip 110 and the input terminal CC2 DFP1 of the second reset chip 120 both output high-level signals (e.g., both SEL1 and SEL2 signals are high-level signals). After the signals pass through the NAND gate circuit 131, PWE is a low-level signal, the current-limiting switch 220 is turned off, and the power supply to the Type-C port of the accessed device 20 is turned off.

The above structure can recognize forward or reverse connection of signals when the Type-C port device is accessed, and control the on or off states of the current-limiting switch 220 to control power supply output of the Type-C port, thereby achieving correct switching of signal channels in the toggle switch 210 when the device is plugged forward or reversely, and ensuring that the port is not live (e.g., powered) when no device is accessed (e.g., connected to the device access circuit 10). Compared with the direct use of an MUX chip, the above structure has a distinct price advantage. Compared with the current design that replaces MUX chips, the problem of failure in the recognition of an external device used by a user due to the normally live port may be solved.

In the description, the reference terms “some examples”, “other examples”, etc., imply that the specific features, structures, materials, or characteristics described in conjunction with such examples are included in at least one example of the present application. In the description, the schematic description of the above terms does not necessarily refer to the same example.

The technical features of the above examples can be combined. For the purpose of simplicity in description, all possible combinations of the technical features in the above examples are not described. However, as long as the combinations of these technical features do not have contradictions, they shall fall within the scope of the description.

The above-mentioned examples only express several implementations of the present application. Their descriptions are relatively specific and detailed, but they should not be construed as limiting the scope of the present application. It should be noted that those of ordinary skill in the art can make variations and improvements without departing from the concept of the present application, and these variations and improvements all fall into the scope of protection of the present application. Therefore, the scope of protection of the present application should be subject to the appended claims.

What is claimed is:

1. A device access circuit, comprising:
a first reset chip;
a second reset chip; and
a logic circuit, wherein:
an input terminal of the first reset chip and an input terminal of the second reset chip are connected to a first port and a second port of a device, respectively,
an output terminal of the first reset chip and an output terminal of the second reset chip are connected to a first input terminal and a second input terminal of the logic circuit, respectively,
the first reset chip and the second reset chip are configured to output different signal levels in response to the device being either in a forward or reverse connection, and
the logic circuit is configured to output a high-level signal in response to the first reset chip and the second reset chip outputting different signal levels.

2. The device access circuit according to claim 1, wherein an output terminal of the logic circuit is connected to a current-limiting switch, and the output terminal of the first reset chip is connected to a toggle switch.

3. The device access circuit according to claim 2, further comprising a signal inverting circuit, wherein the output terminal of the first reset chip is connected to the toggle switch through the signal inverting circuit, and
an on or off state of the signal inverting circuit is based on a signal level output by the first reset chip.

4. The device access circuit according to claim 3, wherein in response to the output terminal of the first reset chip outputting a low-level signal, the signal inverting circuit is in the off state, and in response to the output terminal of the first reset chip outputting a high-level signal, the signal inverting circuit is in the on state.

5. The device access circuit according to claim 3, wherein:
the signal inverting circuit comprises a control switch,
a control terminal of the control switch is connected to the output terminal of the first reset chip,
a first terminal of the control switch is grounded, and
a second terminal of the control switch is connected to the toggle switch.

6. The device access circuit according to claim 5, wherein the control switch comprises a metal oxide semiconductor (MOS) transistor or a triode.

7. The device access circuit according to claim 5, wherein:
the control switch comprises an N-channel metal oxide semiconductor (NMOS) transistor,
a gate of the NMOS transistor is the control terminal,
a source of the NMOS transistor is the first terminal, and
a drain of the NMOS transistor is the second terminal.

8. The device access circuit according to claim 1, wherein the first reset chip is configured to output different signal levels based on a magnitude relationship between an input voltage and a reference voltage.

9. The device access circuit according to claim 1, wherein structures of the first reset chip and the second reset chip are identical.

10. The device access circuit according to claim 2, wherein:
the logic circuit comprises a NAND gate circuit,
a first input terminal of the NAND gate circuit is connected to the output terminal of the first reset chip,
a second input terminal of the NAND gate circuit is connected to the output terminal of the second reset chip, and
an output terminal of the NAND gate circuit is connected to the current-limiting switch.

11. The device access circuit according to claim 1, further comprising a first pull-up resistor and a second pull-up resistor, wherein the input terminal of the first reset chip is connected to a power supply through the first pull-up resistor, and the input terminal of the second reset chip is connected to the power supply through the second pull-up resistor.

12. The device access circuit according to claim 1, further comprising a first filter circuit and a second filter circuit, wherein the first filter circuit is connected to the first reset chip, and the second filter circuit is connected to the second reset chip.

13. The device access circuit according to claim 12, wherein the first filter circuit comprises a first capacitor, and the second filter circuit comprises a second capacitor.

14. The device access circuit according to claim 1, wherein in the forward connection, the first port of the device is connected to the input terminal of the first reset chip, and the second port of the device is connected to the input terminal of the second reset chip; and
in the reverse connection, the first port of the device is connected to the input terminal of the second reset chip, and the second port of the device is connected to the input terminal of the first reset chip.

15. The device access circuit according to claim 14, wherein in the forward connection, the first reset chip is configured to output a low-level signal, and the second reset chip is configured to output a high-level signal, and in the reverse connection, the first reset chip is configured to output a high-level signal, and the second reset chip is configured to output a low-level signal.

16. The device access circuit according to claim 1, wherein the first port and the second port are Type-C ports.

17. The device access circuit according to claim 2, wherein:
the toggle switch comprises a forward connection signal channel and a reverse connection signal channel,
in response to the device being in the forward connection,
the first reset chip is configured to output a low-level signal, and
the forward connection signal channel of the toggle switch is conducted; and
in response to the device being in the reverse connection,
the first reset chip is configured to output a high-level signal, and
the toggle switch switches to the reverse connection signal channel.

18. The device access circuit according to claim 3, wherein:
the signal inverting circuit, in the off state, is configured to output a high-level signal, and
the signal inverting circuit, in the on state, is configured to output a low-level signal.

19. A hub, comprising:
a current-limiting switch;
a toggle switch; and
a device access circuit comprising:
a first reset chip;
a second reset chip; and
a logic circuit, wherein:
an input terminal of the first reset chip and an input terminal of the second reset chip are connected to a first port and a second port of a device, respectively,
an output terminal of the first reset chip and an output terminal of the second reset chip are connected to a first input terminal and a second input terminal of the logic circuit, respectively,
the first reset chip and the second reset chip are configured to output different signal levels in response to the device being either in a forward or reverse connection,
the logic circuit is configured to output a high-level signal in response to the first reset chip and the second reset chip outputting different signal levels, and
an output terminal of the logic circuit is connected to the current-limiting switch, and the output terminal of the first reset chip is connected to the toggle switch.

20. The hub according to claim 19, wherein in the forward connection, the first reset chip is configured to output a low-level signal, and the second reset chip is configured to output a high-level signal, and in the reverse connection, the first reset chip is configured to output a high-level signal, and the second reset chip is configured to output a low-level signal.
